(19) United States
(12) Patent Application Publication
(10) Pub. No.: US 2022/0161346 A1
(43) Pub. Date: May 26, 2022

(54) MULTIPLE PULSED WELDING METHOD

(71) Applicant: Fronius International GmbH, Pettenbach (AT)

(72) Inventor: Dominik SÖLLINGER, Pettenbach (AT)

(73) Assignee: Fronius International GmbH, Pettenbach (AT)

(21) Appl. No.: 17/602,337

(22) PCT Filed: Apr. 9, 2020
(86) PCT No.: PCT/EP2020/060249

§ 371 Date: Oct. 8, 2021

(30) Foreign Application Priority Data
Apr. 10, 2019 (EP) 19168538.7

(51) Int. Cl. B23K 9/09; B23K 9/12; B23K 9/173; B23K 9/095

(52) U.S. Cl. CPC B23K 9/091; B23K 9/0953; B23K 9/1735; B23K 9/124

(57) ABSTRACT

Method and arrangement for carrying out a multiple pulse welding method in which an ideal ratio between the root-mean-square value of the welding current and the welding wire feeding speed is determined from a known relationship between the pulse frequency and the welding wire feeding speed, an actual root-mean-square value of the welding current is determined by the welding current with the pulse frequency to be set, and at least one pulsed current parameter of the welding current of the pulse welding process and/or the welding wire feeding speed of the pulse welding process is changed in order to change the actual ratio to the ideal ratio.

The present invention relates to a method for carrying out a multiple pulse welding method in which at least two pulse welding processes are operated simultaneously, the at least two pulse welding processes each being carried out with a welding current with pulsed current parameters, with a pulse frequency and with a welding wire feeding speedcoupled to the pulse frequency in a known manner, whereas a first pulse welding process defines a first pulse frequency, and the second pulse frequency to be set in a second pulse welding process results from the first pulse frequency. The invention also relates to an arrangement for carrying out the method.

The present invention relates to pulse welding using a consumable electrode with a pulsed arc. In this welding method, a base welding current and a pulsed welding current which is increased in relation to the base welding current alternate regularly at a predefined pulse frequency. During the base welding current phase, the arc burns at low power in order to keep the weld pool liquid. During the pulsed current phase, a droplet of the filler material supplied as a welding wire forms that is ultimately detached and drops into the weld pool. At the same time, the welding wire forms the electrode (consumable electrode), for example in MIG (metal inert gas) or MAG (metal active gas) welding. In MIG/MAG welding, depending on the wire diameter and filler material, the welding wire feeding speed and the pulse frequency are selected and adapted to one another so that a droplet is generated and detached with each current pulse. The welding wire feeding speed and pulse frequency are dependent on one another. If the values for the welding wire feeding speed and the pulse frequency are unsuitably chosen, a stable welding process and/or a good welding quality cannot be achieved. A welding cycle consists of the base welding current phase and the pulse welding current phase and, during pulse welding, is repeated at the pulse frequency. With pulse welding, the heat input into the workpiece can be reduced and controlled, which means that also thinner workpieces can be welded. In addition, pulse welding produces high-quality welding results, for example, welding spatter can be greatly reduced thereby.

In order to increase the welding performance, multiple pulse welding methods, for example a tandem pulse welding method, in which at least two pulse welding processes are operated simultaneously, have become known. At least two welding wires preferably melt down into a common weld pool. However, the individual pulse welding methods can also each have their own weld pool. Separate welding devices are required for each welding process, i.e. in each case a power source, a welding torch and a welding wire feeding unit. Each welding device performs a pulse welding method. Multiple pulse welding can be operated in such a way that the welding processes are started and operated independently of one another, i.e. that the welding current, the welding wire feeding speed and/or the pulse frequency are set individually for each welding process. However, this is more time-consuming for the welder, as the welding parameters must be set accordingly in each welding device. Moreover, there is little to no influence on any mutual interference caused by the welding processes running at the same time, which can reduce the welding quality.

A tandem pulse welding method comprising synchronized welding processes is therefore also already known, in which method one welding device is given a pulse frequency which is followed by the other welding device. Both welding processes are thus synchronized with one another and weld at the same pulse frequency.

Pulse welding processes that are not adapted to one another can lead to problems in a multiple pulse welding method. In MIG/MAG welding, for example, it can be problematic if a welding wire is fed in a pulse welding process at a different welding wire feeding speed than in the other pulse welding process, but this is often desirable in order to increase process stability. However, a lower welding wire feeding speed usually also requires a lower pulse frequency. If there is too great a difference between the welding wire feeding speed of the leading welding process and the following welding process, the following welding process can be operated at too high a pulse frequency (which was adopted from the leading welding process), which means that, in some cases in the following welding process, a stable welding process cannot be achieved or a poor welding result (e.g. weld spatter) is produced.

In order to remedy this problem, DE 10 2007 016 103 A1 has already proposed setting the pulse frequency of a following pulse welding process of a tandem pulse welding process in an integer ratio to the pulse frequency of the leading pulse welding process. The pulse frequencies of the two welding processes are selected so that the pulsed current phases do not overlap. This means that, in the following pulse welding process, welding can be carried out at a lower pulse frequency than in the leading pulse welding process. However, since the pulse frequency can only be changed in an integer ratio, it may be that the pulse welding process of the following welding process is no longer carried out at ideal welding parameters. For example, this can mean that the droplet detachment at the arc of the following pulse welding process no longer functions properly. This can lead to a deterioration in welding quality.

The problem addressed by the present invention is therefore that of providing a method for carrying out a multiple pulse welding method in which the pulse welding processes involved can be operated with settings as ideal as possible.

This problem is solved according to the invention by the features of the independent claims. This guarantees that welding can always be carried out under more ideal welding conditions in all of the pulse welding processes of the multiple pulse welding process. In order to achieve a good welding result, the ratio between the root-mean-square value of the welding current and the welding wire feeding speed is crucial, and this can now be maintained even if the setting values for the pulse welding process are not ideal. In this way, optimal droplet detachment and an arc length that is as constant as possible can be guaranteed in every pulse welding process, which is important for the achieved welding quality.

The second pulse frequency is advantageously obtained from the first pulse frequency from a predefined integer pulse frequency ratio between the first pulse frequency and the second pulse frequency. In this way, the pulse welding processes can be easily synchronized in a manner that is advantageous for the welding method.

In order to prevent excessive interference in the at least one welding parameter, the pulse frequency ratio can also be changed in order to change the actual ratio to the ideal ratio. The at least one welding parameter can then optionally also be changed for fine adjustment.

The root-mean-square value of the welding current, and thus the ratio, can be easily influenced if at least one pulsed current parameter of the welding current of the second pulse welding process is controlled in an open-loop or closed-loop manner to achieve the ideal root-mean-square value as the target value. A pulsed current, a base current, a pulsed current duration, a base current duration, a current rising edge or a current falling edge of the welding current can be changed as at least one pulsed current parameter.

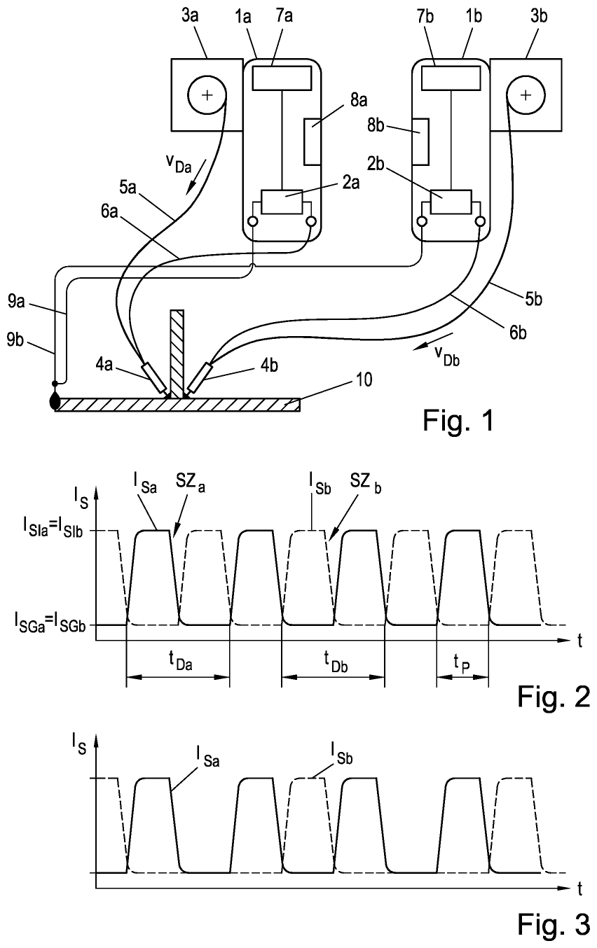

The present invention will be explained in greater detail in the following with reference to FIGS. 1 to 5, which show exemplary advantageous embodiments of the invention in a schematic and non-limiting manner. In the drawings:

FIG. 1 shows an arrangement for carrying out a multiple pulse welding method,

FIG. 2 shows the welding cycles in a multiple pulse welding method that have the same pulse frequencies,

FIG. 3 shows the welding cycles in a multiple pulse welding process that have unequal pulse frequencies,

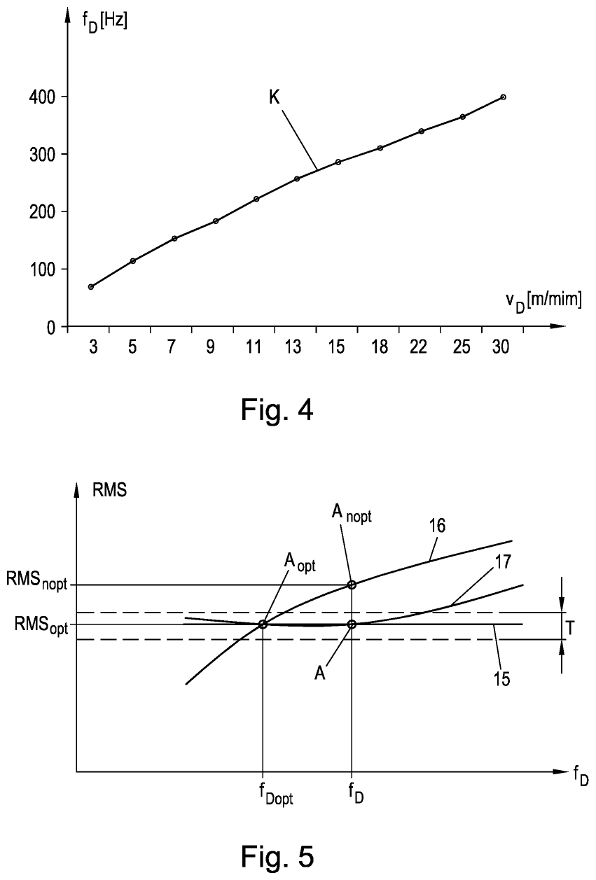

FIG. 4 shows a welding characteristic between the welding wire feeding speed and the pulse frequency, and

FIG. 5 shows a relationship between the root-mean-square value of the welding current and the pulse frequency.

The invention is explained in the following for a tandem pulse welding method, i.e. comprising two pulse welding processes, as an example of a multiple pulse welding method. However, it is of course conceivable to expand the following embodiments to a multiple pulse welding method comprising more than two pulse welding processes. A multiple pulse welding method is characterized in particular in that at least two pulse welding processes run simultaneously. Therefore, in the case of a tandem pulse welding process, two pulse welding processes. The multiple pulse welding processes can all operate in the same weld pool, but different pulse welding processes can also operate in different weld pools.

FIG. 1 is a schematic view of a possible configuration for a tandem pulse welding method, as an example of a multiple pulse welding method that comprises two pulse welding processes which is frequently encountered in practice. Two separate welding devices 1a, 1b are provided, each comprising a power source 2a, 2b, a welding wire feeding unit 3a, 3b and a welding torch 4a, 4b. The power sources 2a, 2b each provide the required welding voltage and the required welding current I_{S}, which are each applied to the welding electrode of the welding process. A welding wire 5a, 5b also simultaneously acts as a consumable welding electrode. For this purpose, for example, a contact sleeve can be provided in a welding torch 4a, 4b, to which sleeve the welding voltage is applied, e.g. via a welding cable 6a, 6b, and which sleeve is contacted by the welding wire 5a, 5b. A particular welding current Is thus flows through the welding electrode, with a ground line 9a, 9b for contacting the workpiece and for closing the welding current circuit of course also being provided therefor. The welding wire 5a, 5b is fed to the welding torch 4a, 4b from the welding wire feeding unit 3a, 3b, in each case at a particular welding wire feeding speed v_{Da}, v_{Db}. The welding wire feeding unit 3a, 3b can be integrated in the corresponding welding device 1a, 1b, but can also be a separate unit. The welding devices 1a, 1b can of course also be arranged in a common housing, if necessary also together with the respective welding wire feeding units 3a, 3b.

The welding wire 5a, 5b and the welding cable 6a, 6b of a welding device 1a, 1b, and possibly also other lines between the power source 2a, 2b and the welding torch 4a, 4b (for example a control line, a shielding gas pipeline or a coolant pipeline) can also be guided in a common, or a plurality of, hosepack(s). The hosepack can be coupled to the welding torch 4a, 4b and to the welding device 1a, 1b via suitable couplings.

A control unit 7a, 7b is also provided in a welding device 1a, 1b, which control unit controls and monitors the pulse welding process carried out by the relevant welding device 1a, 1b. For example, the control unit 7a, 7b controls the power sources 2a, 2b in order to generate the welding current I_{S}. For this purpose, required welding parameters for the pulse welding process to be carried out, such as the pulse frequency f_{D}, the welding wire feeding speed v_{D}, the pulsed current I_{SI}, the base current I_{SG}, the pulsed current duration, the base current duration, rise/fall times of the current edges etc., are predefined or can be set in the control unit 7a, 7b or the power source 2a, 2b. An input/output unit 8a, 8b can also be provided on the welding device 1a, 1b for inputting or displaying particular welding parameters or a welding status. A welding device 1a, 1b of this kind is of course well known and does not need to be described in more detail here. For a multiple pulse welding method comprising more than two pulse welding processes, correspondingly more welding devices 1a, 1b are of course provided.

In order to implement a tandem pulse welding process, in the embodiment shown, the two welding torches 4a, 4b are arranged locally relative to one another and perform welding on a workpiece 10. In the embodiment in FIG. 1, two separate weld seams are produced. The welding torches 4a, 4b therefore operate in separate weld pools. Of course, the welding torches 4a, 4b could also operate in a common weld pool. The arrangement of the welding torches 4a, 4b with respect to one another can be fixed, for example by arranging the two welding torches 4a, 4b on a welding robot (not shown) which guides the two welding torches 4a, 4b. However, the arrangement can also be changeable, for example by guiding each welding torch 4a, 4b with a separate welding robot. It is also irrelevant whether the welding torches 4a, 4b are arranged spatially one behind the other, next to one another or in some other way offset with respect to one another in relation to the welding direction. It is also irrelevant whether a pulse welding process is used to carry out joint welding or weld cladding, or another welding method. These explanations of course also apply in an analogous manner to a multiple pulse welding process comprising more than two pulse welding processes.

The well-known pulse welding method is explained, with reference to FIG. 2, on the basis of the progression of the welding currents I_{Sa}, I_{Sb} of the two pulse welding processes over time t. During the pulse welding, a base current I_{SGa}, I_{SGb} and a pulsed current I_{SIa}, I_{SIb} which is increased in relation to the base current alternate periodically at a predefined pulse frequency f_{Da}, f_{Db}. Of course, the pulse frequency f_{Da}, f_{Db} is obtained as the reciprocal of the period t_{Da}, t_{Db} of a welding cycle SZa, SZb consisting of a base current phase comprising the base current I_{SGa}, I_{SGb} and a pulsed current phase comprising the pulsed current I_{SIA}, I_{SIb}. During the pulsed current phase, a weld droplet is intended to be detached from the welding wire 5a, 5b into the relevant weld pool 11. During welding, the pulse frequency, f_{Da}, f_{Db} and/or the value of the base current I_{SGa}, I_{SGb} or of the pulsed current I_{SIa}, I_{SIb} can also change.

In FIG. 2, the values of the base currents I_{SGa}, I_{SGb} and the values of the pulsed currents I_{SIa}, I_{SIb} of the pulse welding processes are the same, but this is of course not strictly necessary. As a rule, the current values in the pulse welding processes will be different. Likewise, in the example according to FIG. 2, the pulse frequencies f_{Da}, f_{Db} are the same, which is also not strictly necessary. It can also be seen in FIG. 2 that the welding cycles SZa, SZb of the pulse welding processes are offset by a particular phase shift t_{P}, in this case 180°, i.e. that current pulses with the pulsed current of the pulse welding processes are set so as to be alternate over time tin this example. Any other phase shift, however, in particular also zero, is of course also conceivable and can be set.

Of course, the pulsed current durations and the base current durations in the respective welding cycles SZa, SZb also do not have to be the same and can also change during welding. The same applies to other pulsed current parameters of the welding currents I_{S1}, I_{S2}, such as edge rising and edge falling times, durations of the pulse phases or base current phases, or values of the pulsed or base currents.

The time curves of the welding currents I_{Sa}, I_{Sb} are of course shown in an idealized and simplified manner in FIG. 2. In reality, of course, there will be certain current ramps on the edges, which can also be set. It is also often provided that the welding current I_{S} drops in steps or with a different current curve during the transition from the pulsed current I_{SI} to the base current I_{SG}, in order to promote droplet detachment. Short intermediate current pulses are also often provided in the base current phase in order to increase process stability. However, this does not change the period t_{Da}, t_{Db} of a welding cycle SZa, SZb and the pulse to frequency f_{Da}, f_{Db} obtained therefrom.

The pulse frequency f_{D} and the welding wire feeding speed v_{D} are coupled in a pulse welding process and are dependent on one another, as shown in FIG. 4. It can be seen that the pulse frequency f_{D} increases when the welding wire feeding speed v_{D} increases and vice versa. This relationship is either known or can be determined empirically or from suitable models, also in dependence from different process parameters such as different welding wires (e.g.

material, thickness, etc.), different seam shapes, etc., and can be stored as a characteristic curve K in the welding devices 1a, 1b. The form in which the characteristic curve K is stored, for example as a table, as a model (also in dependence from other parameters such as material and thickness) or by means of a formula (e.g. approximated straight line or curve) does not matter.

In a multiple pulse welding process according to the invention, the pulse welding processes are synchronized with one another in that the pulse frequencies f_{Da}=1/t_{Da}, f_{Db}=1/t_{Db} of the pulse welding processes being related to one another in a particular predefined manner. When the pulse frequencies f_{Da}, f_{Db} are synchronized, one pulse frequency f_{Da} is preferably in an integer pulse frequency ratio to the other pulse frequency f_{Db}. The pulse frequency ratio of the pulse frequencies f_{Da}, f_{Db} to one another that is required for the multiple pulse welding method to be carried out is predefined or set in the welding devices 1a, 1b. In the example of FIG. 2, the pulse frequency f_{Da}, for example of the leading pulse welding process, is the same as the pulse frequency f_{Db}, for example of the following pulse welding process. In the embodiment according to FIG. 3, the pulse frequency f_{Da}, for example of the leading pulse welding process, is twice as high as the pulse frequency f_{Db}, for example of the following pulse welding process, but this can also be the other way round.

Usually the leading pulse welding process will have the higher pulse frequency f_{Da} and the following pulse welding process will have the lower or the same pulse frequency f_{Db}. In the case of a multiple pulse welding method, there is a leading pulse welding process and a plurality of following pulse welding processes, with the leading pulse welding process also preferably having the highest pulse frequency and the following pulse welding processes having lower or equal pulse frequencies. The pulse frequencies of the following pulse welding processes do not necessarily have to be the same.

Which pulse welding process is the leading and which is the following can be predefined or set on the welding devices 1a, 1b and can also change during welding. For settings, the welding devices 1a, 1b can be connected to one another via a communication line and can also be connected to a higher-level control unit. The control unit can also define which pulse welding process is intended to be the leading process.

However, because of the synchronization of the pulse frequency of a following pulse welding process to the pulse frequency of the leading pulse welding process (or vice versa) via the pulse frequency ratio, the synchronizing pulse welding process can be negatively influenced.

The welding result can be negatively influenced if welding is intended to be carried out in a pulse welding process at a welding wire feeding speed v_{D} which, on the basis of the characteristic curve K, does not match the pulse frequency obtained from the pulse frequency ratio. For example, a first pulse welding process is intended to be operated with the setting values for the welding wire feeding speed v_{Da}=16 m/min and a pulse frequency coupled thereto (from the characteristic curve K) f_{Da}=300 Hz. A second pulse welding process synchronized with the first pulse welding process is intended to be operated, according to specifications, at a welding wire feeding speed v_{Da}=10 m/min, which would require an ideal pulse frequency f_{Db}=150 Hz because of the coupling. However, on the basis of the set pulse frequency ratio of f_{Da}/f_{Db}=1, the second pulse welding process actually has to be operated at 300 Hz. These non-ideal settings in the second pulse welding process can lead to an undesirable change in the arc length in the pulse welding process. For example, the arc length can increase in the pulse welding process and the arc can break off because the welding wire 5b burns off more quickly. However, the arc can also become too short if the welding wire 5b burns off too slowly, which in turn can lead to long-lasting short circuits and associated weld seam defects. This can disrupt the pulse welding process and negatively affect the welding quality, for example because the droplet detachment no longer functions properly. In the worst case, the pulse welding process becomes unstable and/or no longer functions properly, which leads for example to weld spatter, loss of the common weld pool, undercuts, pores in the weld seam, too much burn-off of the alloying elements, etc. In order to mitigate this, the associated coupled pulse frequency f_{Db} is taken for the synchronizing pulse welding process according to the set welding wire feeding speed v_{Db} from the stored characteristic curve K and the ratio, set to the nearest integer, between the new pulse frequency f_{Da} in the leading pulse welding process and the taken pulse frequency f_{Db} in the following pulse welding process is determined as the new pulse frequency ratio and is newly set. The pulse frequency f_{Db} in the synchronizing pulse welding process is then determined from the pulse frequency f_{Da} in the leading pulse welding process and the newly determined pulse frequency ratio and accordingly set. In this way, the deviation in the following pulse welding process between the ideal ratio of the welding wire feeding speed v_{Db} and pulse frequency f_{Db} to the actually set ratio becomes smaller.

The same problem can arise if the welding wire feeding speed v_{Da} or the pulse frequency f_{Da} of one of the pulse welding processes is changed at the beginning or during welding in a multiple pulse welding process. On the basis of the set pulse frequency ratio between the pulse frequencies f_{Da}, f_{Db} in the pulse welding processes, this also leads to a change in the pulse frequency f_{Db} of the synchronizing pulse welding process. Nevertheless, this changed to pulse frequency f_{Db} no longer matches the welding wire feeding speed v_{Db} set in the pulse welding process.

According to the invention, in order to remedy this problem, welding parameters are adapted in order to reduce the above-explained possible effects of a deviation from ideal setting values. Non-ideal setting values of this kind can occur, for example, in the event of a change to a welding wire feeding speed v_{Da}, v_{Db}, a welding current I_{Sa}, I_{Sb}, a welding voltage, the material thickness of the workpiece to be welded, etc. According to the invention, at least one welding parameter of a synchronizing (for example the following) pulse welding process is changed, so that the actual ratio V between the actual root-mean-square value of the welding current I_{Sb} and the actual welding wire feeding speed v_{Db} is changed to the ideal ratio Vₒₚₜ which is obtained from the ideal setting values. The actual ratio V is therefore obtained from the actual setting values with which welding is carried out. The ideal ratio Vₒₚₜ is obtained from the values which would have to be set on the basis of the coupling between pulse frequency f_{D} and welding wire feeding speed v_{D}, but which cannot be set on the basis of the predefined pulse frequency ratio. The at least one welding parameter to be changed is therefore a pulsed current parameter that changes the time curve of the welding current I_{Sb} (i.e. the curve shape), for example the pulsed current I_{SI}, the base current I_{SG}, the pulsed current duration and the base current duration (preferably in relation to the duration of a welding cycle SZ), rise/fall times of the current edges, etc., which influences the root-mean-square value of the welding current I_{S}. However, the welding wire feeding speed v_{Db} can also be changed as a welding parameter.

The invention is based on the fact that ideal setting values for the pulse frequency f_{D} and for the welding wire feeding speed v_{D} are determined from a known relationship (characteristic curve K) between the pulse frequency f_{D} and the welding wire feeding speed v_{D} of a pulse welding process, whereas the predefined value for either the pulse frequency f_{D} or the welding wire feeding speed v_{D} being used for the determination. By means of the ideal setting values, an ideal root-mean-square value RMSₒₚₜ of the welding current Is can be determined, from which an ideal ratio Vₒₚₜ between the ideal root-mean-square value RMSₒₚₜ and the ideal welding wire feeding speed v_{D} can then be determined by means of the ideal setting value of the welding wire feeding speed v_{D}. This ideal ratio Vₒₚₜ is then set by changing at least one welding parameter. The welding wire feeding speed v_{D} of the pulse welding process that is to be set can be coupled to an ideal pulse frequency f_{D} via the relationship or the pulse frequency f_{D} of the pulse welding process that is to be set can be coupled to an ideal welding wire feeding speed v_{D}. In this way, an ideal root-mean-square value RMSₒₚₜ of the welding current can be determined from the welding current I_{S} together with the ideal pulse frequency f_{Dopt}, and from this an ideal ratio Vₒₚₜ between this ideal root-mean-square value RMSₒₚₜ and the predefined welding wire feeding speed v_{D} can be to determined. Likewise, an ideal root-mean-square value RMSₒₚₜ of the welding current I_{S} can be determined from the welding current I_{S} together with the pulse frequency f_{D} to be set, and from this an ideal ratio Vₒₚₜ between this ideal root-mean-square value RMSₒₚₜ and the ideal welding wire feeding speed v_{D} can be determined.

The root-mean-square value of a electrical variable which varies over time is known to be the quadratic mean of this electrical variable over time. The root-mean-square value of the welding current I_{S} can therefore be calculated, for example, over a period to of a welding cycle SZ. However, it is more advantageous to calculate the root-mean-square value over a plurality of periods t_{D} (for example as a moving average) or to average the root-mean-square values determined for different periods t_{D}.

It is irrelevant to the invention which welding parameter is changed, with it also being possible to change a plurality of welding parameters at the same time. For example, an algorithm can be implemented that makes this change. The algorithm can make changes to at least one welding parameter on the basis of stored empirical data, for example a relationship between the root-mean-square value and certain pulsed current parameters. Likewise, a model, either a physical or a trained model (e.g. neural network), could be provided which maps a desired change in the root-mean-square value onto a specific change in the at least one welding parameter. In the same way, an optimization could be implemented that changes the at least one welding parameter in such a way that the desired root-mean-square value is approximated as closely as possible. For this purpose, for example, a cost function of the deviation between the current root-mean-square value and the desired root-mean-square value (also as a quadratic deviation) could be minimized by changing the at least one welding parameter. Boundary conditions such as predefined limits (possible minimum or maximum values) of the welding parameter can also be taken into account. In an advantageous implementation, characteristic maps can be stored in the welding device 1a, 1b, which characteristic maps show the influence of particular welding parameters on the root-mean-square value of the welding current I_{S}. Changes to welding parameters can then be taken from the stored characteristic maps in order to change the root-mean-square value in the desired manner. This advantageously makes sure that the droplet detachment is guaranteed despite adjustments to the welding current I_{S}. For this purpose, limit values for the different welding parameters can also be stored, optionally also in dependence of other parameters of the multiple pulse welding method, for example material thickness of the workpiece to be welded, diameter/material of the welding wire, etc.

In an advantageous embodiment, for example, a characteristic map can be stored, e.g. in the form of a table, which map stores information regarding by how much (e.g. in percent or absolute) at least one pulsed current parameter has to be changed in order to compensate for a deviation (e.g. in percent or absolute) of the pulse frequency f_{D} from the ideal pulse to frequency (or the deviation of the welding wire feeding speed v_{D} from the ideal welding wire feeding speed) in order to change the root-mean-square value RMS so that the desired ideal ratio Vₒₚₜ is achieved. For example, the change in base current I_{SG}, pulsed current I_{SI} and pulsed current duration could be stored in the table as pulsed current parameters in dependence of the change in pulse frequency f_{D}.

As a rule, it will not be possible to change the set actual ratio V exactly to the ideal ratio Vₒₚₜ between the root-mean-square value and the welding wire feeding speed y_{Db}, because the welding parameters cannot of course be changed at will. Therefore, to change to this ideal ratio Vₒₚₜ means, in the context of the invention, that the ratio Vₒₚₜ is substantially achieved, and that the resulting actual ratio V is therefore preferably within a defined tolerance window around the desired ideal ratio Vₒₚₜ, the tolerance window preferably being ±25%, very particularly preferably ±10%, of the desired ratio. This is explained with reference to FIG. 5.

FIG. 5 shows, by way of example, the relationship between the pulse frequency f_{D} and the root-mean-square value RMS of the welding current I_{S} of a pulse welding process. On the basis of the characteristic curve K (FIG. 4), the pulse welding process would have to be operated at an ideal operating point Aₒₚₜ at an ideal pulse frequency f_{Dopt} on the basis of a set welding wire feeding speed v_{D}, which results in a root-mean-square value RMSₒₚₜ and an ideal ratio Vₒₚₜ between these two variables. However, because of the predefined pulse frequency ratio, the pulse welding process has to be operated at an actual pulse frequency f_{D}, which would result in an actual operating point Aₙₒₚₜ with non-ideal setting values for the pulse welding process and in an actual root-mean-square value RMSₙₒₚₜ (line 16) and in an actual ratio V. The aim of the invention is to set the ideal ratio Vₒₚₜ obtained from the ideal setting values at the ideal operating point Aₒₚₜ (line 15). For this purpose, in the embodiment shown, at least one pulsed current parameter of the welding current I_{S} is changed as a welding parameter, so that, at the pulse frequency f_{D} to be set on the basis of the predefined pulse frequency ratio, the root-mean-square value RMSₒₚₜ and thus the ideal ratio Vₒₚₜ is achieved (line 17), preferably within a tolerance window T. The pulse welding process is carried out with the setting values determined in this way for the welding current I_{S} and the welding wire feeding speed v_{D} at the operating point A.

The same procedure can of course be followed if, instead of a pulsed current parameter, the welding wire feeding speed v_{D} is changed as a welding parameter in order to set the ideal ratio Vₒₚₜ. In the same way, of course, the welding wire feeding speed v_{D} and at least one pulsed current parameter can also be changed as welding parameters in order to set the ideal ratio Vₒₚₜ.

In a possible implementation of the invention, closed-loop control could also be provided for the root-mean-square value RMS of the welding current I_{S}, in order to set the ideal ratio Vₒₚₜ as best as possible. For this purpose, a closed-loop controller can be implemented, for example as software in the control unit 7 of a pulse welding process, in order to control at least one pulsed current parameter as a welding parameter in a closed-loop manner so that the ideal ratio Vₒₚₜ is adjusted as the target value during welding. Likewise, an open-loop controller can be implemented that sets the ideal ratio Vₒₚₜ as a target value.

In addition to changing the root-mean-square value of the welding current I_{Sb} and/or the welding wire feeding speed v_{Db} to achieve the ideal ratio Vₒₚₜ, in an embodiment of the invention the pulse frequency ratio can also be changed. If, in order to achieve the ideal ratio Vₒₚₜ, the welding wire feeding speed v_{Db} and/or the root-mean-square value of the welding current I_{Sb} would have to be changed too much, provision can be made, for example, to first change the pulse frequency ratio, and thus the pulse frequency f_{Db} of the synchronizing pulse welding process, to a different larger or smaller integer value. This can be done, for example, if the welding wire feeding speed v_{Db} or the root-mean-square value RMS would have to be changed by more than ±25%. After changing the pulse frequency ratio, the ratio V can also be adjusted if necessary.

If, in order to achieve the ideal ratio Vₒₚₜ, the welding wire feeding speed v_{Db} in the following pulse welding process is changed, then it is preferably set to the value that is obtained from the characteristic curve K (FIG. 4) of the pulse welding process on the basis of the set pulse frequency f_{Db} (which is synchronized with the pulse frequency f_{Da} of the leading pulse welding process and is thus fixed).

In order to control the pulse welding processes of a multiple pulse welding method, the following procedure can be carried out according to the invention.

Basic preliminary settings, such as the definition of which pulse welding process is the leading and which is the following or the definition of the welding wire feeding speeds v_{Da}, v_{Db} and the pulse frequencies f_{Da}, f_{Db} or the operating points of the pulse welding processes, are assumed to be given. The multiple pulse welding method is started with these basic settings, i.e. the arcs are ignited in a known manner and synchronisation of the pulse welding processes involved is carried out.

As the pulse frequency f_{Db} of the following pulse welding process is obtained on the basis of the defined integer pulse frequency ratio between the pulse frequencies f_{Da}, f_{Db}, it is possible, as a preliminary step, to change the welding wire feeding speed v_{Db} to the welding wire feeding speed v_{Db} that corresponds to the resulting pulse frequency f_{Db} (for example on the basis of the stored characteristic curve K). This means that the multiple pulse welding method can also be started in the following pulse welding process with ideally matching pulse frequency f_{Db} and welding wire feeding speed v_{Db}. Of course, the same could also be to done in the leading pulse welding process.

With the specifications for the welding wire feeding speeds v_{Da}, v_{Db} of the pulse welding processes of the multiple pulse welding method, the ideal pulse frequencies f_{Da}, f_{Db} are obtained or, vice versa, the ideal welding wire feeding speeds v_{Da}, v_{Db} are obtained from the pulse frequencies f_{Da}, f_{Db}. By means of the known setting values of the pulsed current parameters for the welding current I_{Sb} (which are known in the welding device 1b) of the synchronizing pulse welding process, the root-mean-square value RMSₒₚₜ and subsequently the ratio vₒₚₜ can be determined (for example mathematically or by means of measurement). The actual root-mean-square value RMSₙₒₚₜ and the actual ratio Vₙₒₚₜ are determined at the beginning of the multiple pulse welding method or also continuously during welding or only if either a pulse frequency f_{Da}, f_{Db} and/or a welding wire feeding speed v_{Da}, v_{Db} of a pulse welding process is changed during the multiple pulse welding process, for example by the welder or on the basis of a specification from a higher-level control unit or on the basis of an ongoing welding program. In this way, at least one welding parameter of the synchronizing pulse welding process can be changed in order to set the desired ratio Vₒₚₜ.

If, during the multiple pulse welding method, either a pulse frequency f_{Da}, f_{Db} and/or a welding wire feeding speed v_{Da}, v_{Db} of a pulse welding process is changed, for example by the welder or on the basis of a specification from a higher-level control unit or on the basis of an ongoing welding program, the pulse frequencies f_{Da}, f_{Db} remain, due to the synchronization of the welding devices 1a, 1b, in an integer pulse frequency ratio that either remains unchanged or can also change. This can therefore be accompanied by an adjustment of the pulse frequencies f_{Da}, f_{Db}, in particular the pulse frequency of the following pulse welding process, and thus by a change in the root-mean-square value RMS. Depending on the implementation of the adjustment, the root-mean-square value of the welding current I_{S} and/or the welding wire feeding speed v_{Db} of the following pulse welding process can be changed in order to substantially set the desired ideal ratio Vₒₚₜ.

For example, preference can be given to changing the welding wire feeding speed v_{Db} if the integer pulse frequency ratio of the pulse frequencies f_{Da}, f_{Db} changed. In addition, the root-mean-square value of the welding current I_{S} can also be adjusted for a fine adjustment. On the other hand, preference could be given to adjusting the root-mean-square value if the welding wire feeding speed v_{Db} needed to change by more than a defined value, for example by 10%.

The ideal ratio Vₒₚₜ can thus also change during welding, which can also make it necessary to change a welding parameter in order to set this changed ideal ratio Vₒₚₜ. A change of this kind can result, for example, from higher-level control of an arc length, which can bring about to changes in the welding current I_{S} or the welding wire feeding speed v_{D}.

The adjustment of the at least one welding parameter can be implemented as software in a control unit 7a, 7b of a welding device 1a, 1b. The data necessary for this, such as characteristic maps, can be stored in the welding device 1a, 1b.

1. A method for carrying out a multiple pulse welding method in which at least two pulse welding processes are operated simultaneously, the at least two pulse welding processes each being carried out with a welding current with pulsed current parameters, with a pulse frequency to be set and with a welding wire feeding speed to be set, whereas a first pulse welding process defines a first pulse frequency, and the second pulse frequency to be set in a second pulse welding process results from the first pulse frequency wherein ideal setting values for the second pulse frequency and for the second welding wire feeding speed are determined from a known relationship between the pulse frequency and the welding wire feeding speed of the second pulse welding process, wherein an ideal root-mean-square value of the second welding current is determined by the ideal setting values, and an ideal ratio between the root-mean-square value and the welding wire feeding speed is determined by the ideal root-mean-square value and the ideal setting value of the second welding wire feeding speed, wherein an actual root-mean-square value of the second welding current is determined by the second welding current with the second pulse frequency to be set, and from that an actual ratio between the actual root-mean-square value and the welding wire feeding speed of the second pulse welding process that is to be set is determined, and wherein at least one pulsed current parameter of the second welding current of the second pulse welding process and/or the welding wire feeding speed of the second pulse welding process is changed in order to change the actual ratio to the ideal ratio.

2. The method according to claim 1, wherein the welding wire feeding speed of the second pulse welding process that is to be set is coupled to an ideal second pulse frequency or the second pulse frequency of the second pulse welding process that is to be set is coupled to an ideal second welding wire feeding speed, and wherein an ideal root-mean-square value of the second welding current is determined from the second welding current with the ideal second pulse frequency and from this the ideal ratio between this ideal root-mean-square value and the predefined welding wire feeding speed is determined, or an ideal root-mean-square value of the second welding current is determined from the second welding current with the second pulse frequency to be set and from this an ideal ratio between this ideal root-mean-square value and the ideal welding wire feeding speed is determined.

3. The method according to claim 1, wherein the second pulse frequency is obtained from the first pulse frequency from a predefined integer pulse frequency ratio between the first pulse frequency and the second pulse frequency.

4. The method according to claim 3, wherein the pulse frequency ratio is also changed in order to change the actual ratio to the ideal ratio (Vₒₚₜ).

5. The method according to claim 1, wherein the root-mean-square value of the welding current of the second pulse welding process is controlled in an open-loop or closed-loop manner by changing at least one pulsed current parameter of the welding current of the second pulse welding process to achieve the ideal root-mean-square value as the target value.

6. The method according to claim 1, wherein a pulsed current, a base current, a pulsed current duration, a base current duration, a current rising edge or a current falling edge of the second welding current is changed as at least one pulsed current parameter.

7. An arrangement for carrying out a multiple pulse welding method in which at least two welding devices each carry our a pulse welding process with a welding current with pulsed current parameters, with a pulse frequency to be set and with a welding wire feeding speed to be set, whereas a first pulse welding process defines a first pulse frequency and the second pulse frequency to be set in a second pulse welding process results from the first pulse frequency, wherein a control unit which executes the second pulse welding process determines an ideal root-mean-square value of the second welding current, wherein the control unit determines ideal setting values for the second pulse frequency and for the second welding wire feeding speed from a known relationship between the pulse frequency and the welding wire feeding speed of the second pulse welding process, and wherein the control unit determines the ideal root-mean-square value of the second welding current by the ideal setting values, wherein the control unit determines an ideal ratio between the root-mean-square value and the welding wire feeding speed by the ideal root-mean-square value and the ideal setting value of the second welding wire feeding speed, wherein the control unit determines an actual root-mean-square value of the second welding current by the second welding current with the second pulse frequency to be set, and further determines an actual ratio between the actual root-mean-square value and the welding wire feeding speed of the second pulse welding process that is to be set, and wherein the control unit changes at least one pulsed current parameter of the second welding current of the second pulse welding process and/or the welding wire feeding speed of the second pulse welding process in order to change the actual ratio to the ideal ratio.

8. The arrangement according to claim 7, wherein the control unit determines, from the welding wire feeding speed of the second pulse welding process that is to be set, an ideal second pulse frequency coupled thereto or, from the second pulse frequency of the second pulse welding process that is to be set, an ideal second welding wire feeding speed coupled thereto, and the control unit determines the ideal root-mean-square value of the second welding current from the second welding current with the ideal second pulse frequency or with the second pulse frequency to be set, and the control unit determines the ideal ratio between this ideal root-mean-square value and the welding wire feeding speed that is to be set or is ideal.
